(19) United States
(12) Patent Application Publication
(10) Pub. No.: US 2003/0063894 A1
(43) Pub. Date: Apr. 3, 2003

(54) Video editing system and the method thereof

(76) Inventors: Mong-Ling Chiao, Taipei (TW); Bei-Chuan Chen, Taipei (TW); Min-Chi Ko, Taipei (TW)

Correspondence Address: Keith Kline, PRO-TECHTOR INTERNATIONAL SERVICES, 20775 Norada Court, Saratoga, CA, 95070-3018, US

(21) Appl. No.: 10/234,599

(22) Filed: Sep. 3, 2002

(30) Foreign Application Priority Data
Sep. 28, 2001 (TW) 090124057

(51) Int. Cl. H04N 5/76; G11B 27/02; G11B 27/00

(52) U.S. Cl. 386/52; 360/13

(57) ABSTRACT

The invention discloses a video editing system with the corresponding method thereof that applies to dynamically edit a plurality of video information to a compact disk. The video editing system comprises a capture device, a format-making device and a burning device. The capture device provides an operation interface to record the starting location and the ending location of the plurality sections and then become a data stream. The format-making device produces a file system and a video compact disk data section that matches the format of the compact disk through the data stream. The burning device records the file system and the video compact disk data section into the compact disk, and then corrects each section head and the error-detecting code of the disk to load the said data stream in sequence. Finally, burn the said data stream into the compact disk.

### BACKGROUND OF THE INVENTION

### DESCRIPTION OF THE RELATED ART

Now there are various kinds of video editing software in the market, most of them only provide users the functions of burning, transmission, compression, input and output or create/edit etc. such users always buy many video compact disks, but only want to collect some part of the film. And it seems to be a great work to finish it through some video editing software.

According to the foregoing description, this invention discloses a video edit system, by that, users can capture any section of the video file and collect the captured sections to produce a complete video information they anticipated and present it in a compact disk.

### SUMMARY OF THE INVENTION

The main objective of the invention is to provide users a video editing system, by that, users can capture any section of the video file and collect the captured video sections to produce a complete video information and burn in a compact disk.

The objective of the invention is to provide users a video editing method; any kind of video edit capture system can easily reach their needs by that.

The other objective of the invention is to provide users a video editing system, by that, users can capture a batch of sections of the video file and collect the captured sections to produce a video information and burn in a compact disk.

The video editing system comprises a capture device, a format-making device and a burning device. The capture device provides an operation interface to record the starting location and the ending location of the plurality sections in such video file and then become a data stream. The format-making device produces a file system and a video compact disk data section that matches the format of the compact disk through the data stream. The burning device records the file system and the data section of the video compact disk into the compact disk, and then corrects each section head and the error-detecting code of the compact disk to load the said data stream in sequence. Finally, burn the said data stream into the compact disk.

Furthermore, the video editing system also can apply to software-design, the video edit software comprises at least one main program, a capture function program, a format-making function program and a burning function program. It can generate an operation window in a screen through the main program. And through calling the capture function program, it can play a plurality of video compact disk in the operation window as soon as possible to record the starting location and the ending location of such video compact disks through a previous setting to a file. After the capture function program records a plurality of sections, the capture function program can produce a sequence of data stream and call the format-making function program. The format-making function program produce a file system that matches the compact disk form and a video compact disk information field through the data stream, and then call the burning function program. The burning function program can check whether the recorder is such as CD-R or CD-RW putted a blank compact disk or not, and then records the file system and video compact information data field to this blank compact disk. And corrects each section head and the error-detecting code of the video compact disk to load a data stream in sequence then burn the said data stream to the compact disk in sequence. Finally, it becomes the video compact disk that users edit.

Besides, the video editing method of the invention comprises the following steps:

(a) Recording the starting location and the ending location to form a data stream;

(b) Generating a file system that matches the compact disk form and a video compact disk information field through the data stream;

(c) Burning the file system and video compact information data field to the blank compact disk;

(d) Correcting each section head and the error-detecting code of the video compact disk to load the said data stream in sequence; and

(e) Burning the data stream to the blank compact disk in sequence.

### BRIEF DESCRIPTION OF DRAWINGS

The following detailed description, given by way of examples and not intended to limit the invention to the embodiment described herein, will best be understood in conjunction with the accompanying drawings, in which:

FIG. 1 illustrates the system structure of the example one;

FIG. 2 illustrates the operation action of the capture device 101;

FIG. 3 illustrates the operation action of the format-making device 102;

FIG. 4 illustrates the operation action of the burning device 103-1;

FIG. 5 illustrates the operation action of the burning device 103-2;

FIG. 6 illustrates the flow chart about the video editing method of this invention;

FIG. 7 illustrates the system structure of the example two;

FIG. 8 illustrates how the main program 700 and the capture function program 701 work in coordination;

FIG. 9 illustrates how the capture function program 701 and the format-making function program 701 work in coordination;

FIG. 10 illustrates the action of the burning function program;

FIG. 11 illustrates the real operation action of the two examples.

### DETAILED DESCRIPTION ONE OF THE INVENTION

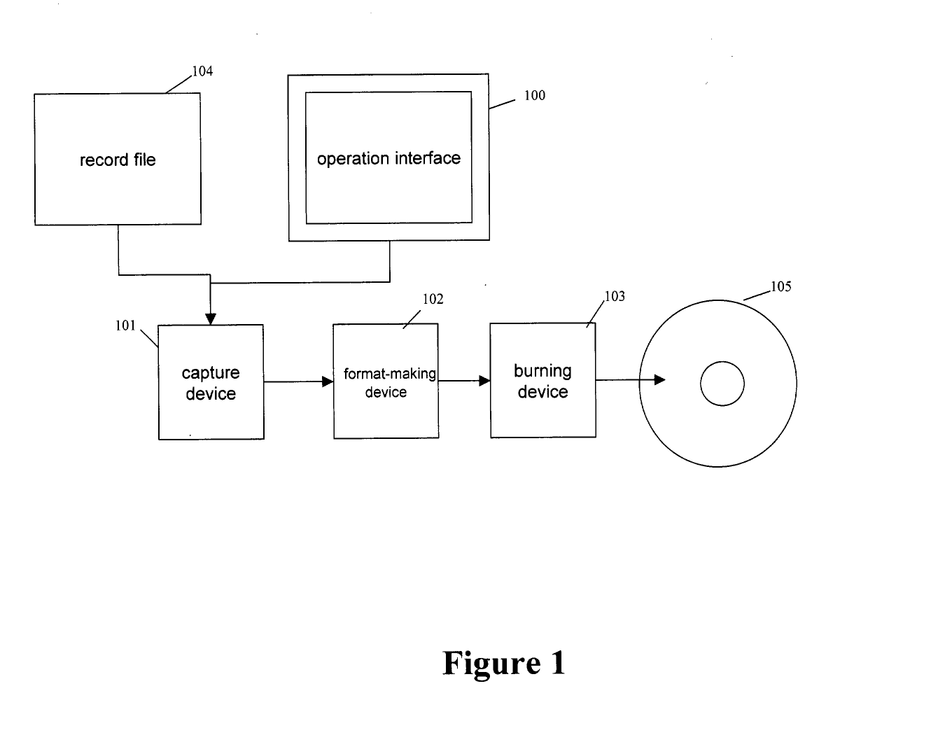

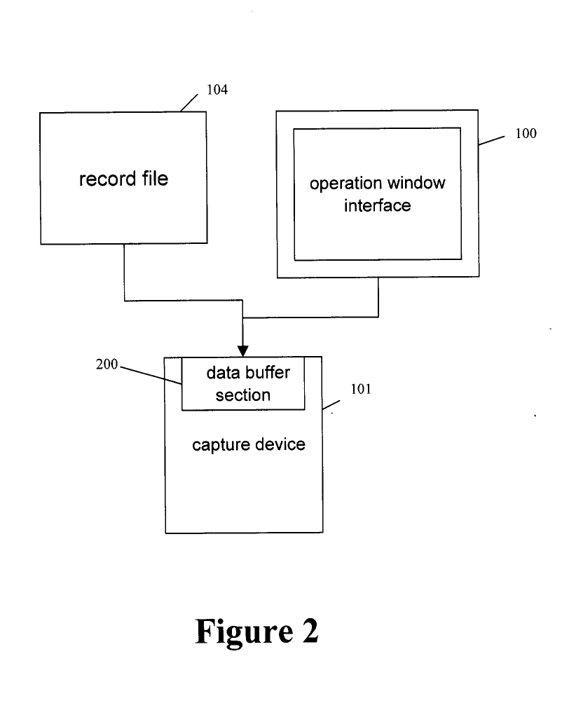

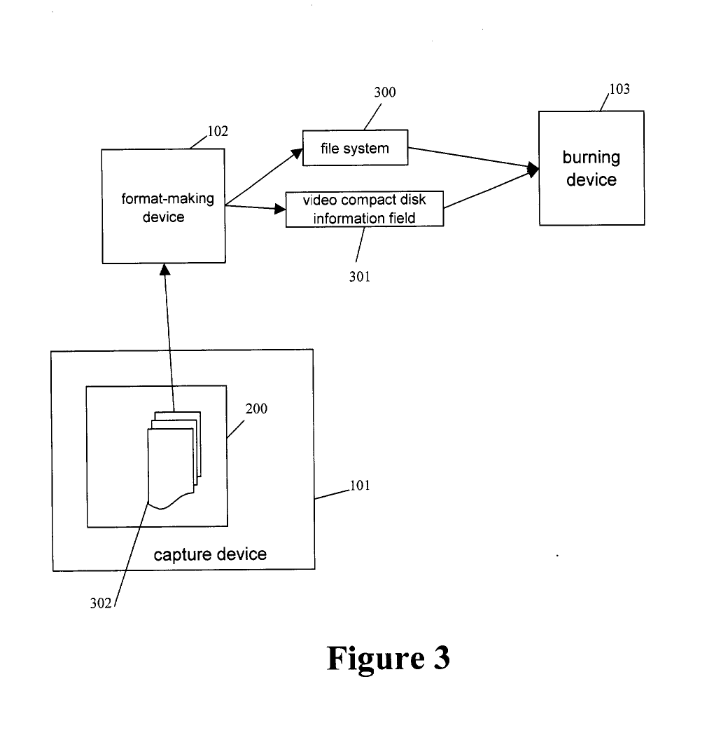

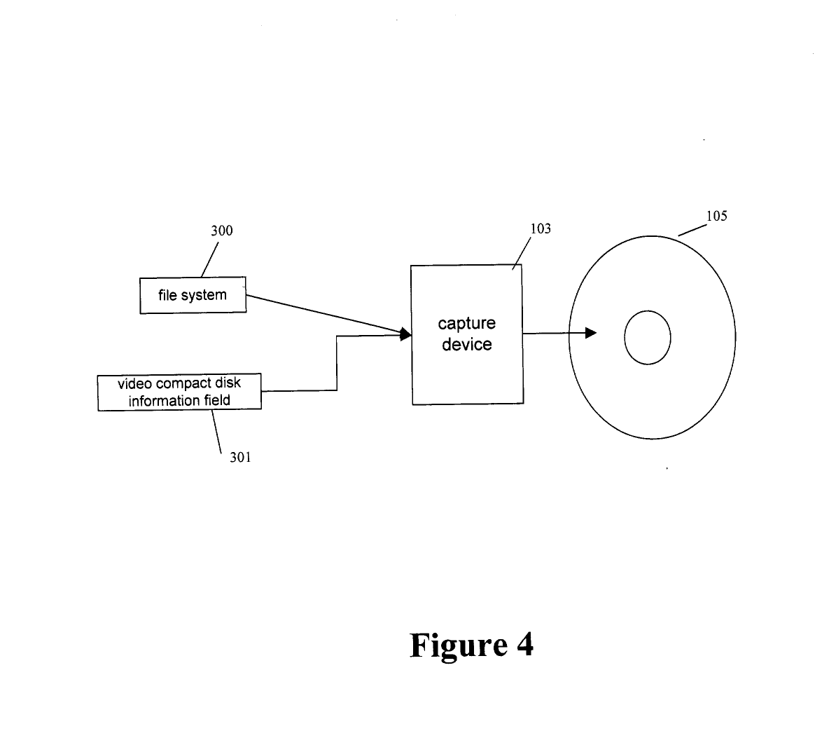

FIG. 1 illustrates the system structure of the example that comprises an operation interface 100, a record file 104, a capture device 101, a format-making device 102, a burning device 103 and a targeted compact disk 105. We can get the idea from this figure, the connection about the said components are: the operation interface 100 and the record file 104 connect the capture device 101, the capture device 101 connect the format-making device 102, the format-making device 102 connect the burning device 103 and the burning device 103 connect the control component of the targeted compact disk 105(that is not shown in the figure). FIG. 2 illustrates the operation action of the capture device 101. In this figure, the capture device 101 records the starting location and the ending location of the plurality sections through the operation interface 100 or the record file 104 and records them in the data buffer section 200 of the capture device 101. Coming after the FIG. 3, it illustrates the operation action of the format-making device 102. The format-making device produces a file system 300 that matches the compact disk form and a video compact disk information field 301 through the plurality sections 302 recorded in the data buffer section 200 of the capture device 101,and then transmits them to the burning device 103. FIG. 4 illustrates the operation action one of the burning device 103; the burning device 103previously burns the file system 300 and the video compact disk information field 301 to the objective disk 105.

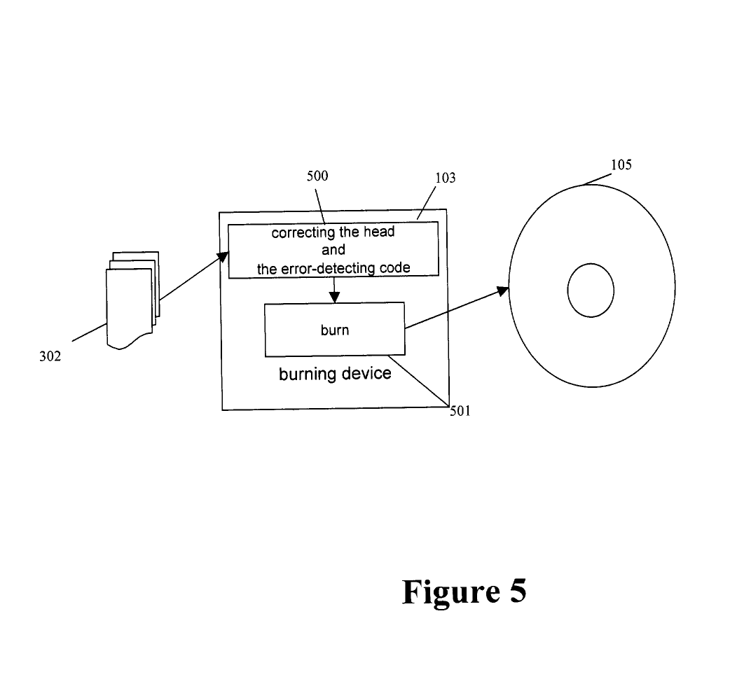

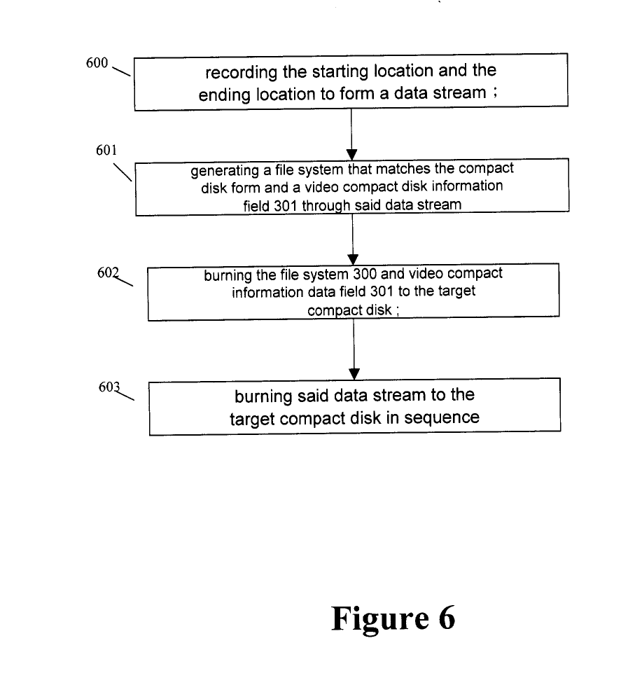

FIG. 5 illustrates the operation action two of the burning device 103,the burning device 103 comprises at least two functions, one function is correcting the head and the error-detecting code 500,and the other function is burning 501. The burning device 103 reads the plurality sections 302 through the capture device 101 and the format-making device in sequence, and then corrects each section head and the error-detecting code of the targeted compact disk 105 through the function 500 of correcting head and error-detecting to burn the plurality sections 302 to the targeted compact disk 105 in sequence. Besides, the video editing method of the invention is comprised of the following steps shown as the FIG. 6; step 600: recording the starting location and the ending location 200 to form a data stream. Step 601: generating a file system 300 that matches the compact disk form and a video compact disk information field 301 through the said data stream. Step 602: burning the file system 300 and video compact information data field 301 to the targeted compact disk 105, and then correcting each section head and the error-detecting code of the targeted compact disk 105 to load the said data stream in sequence. Finally, step 603, burning the said data stream to the targeted compact disk 105 in sequence.

### DETAILED DESCRIPTION TWO OF THE INVENTION

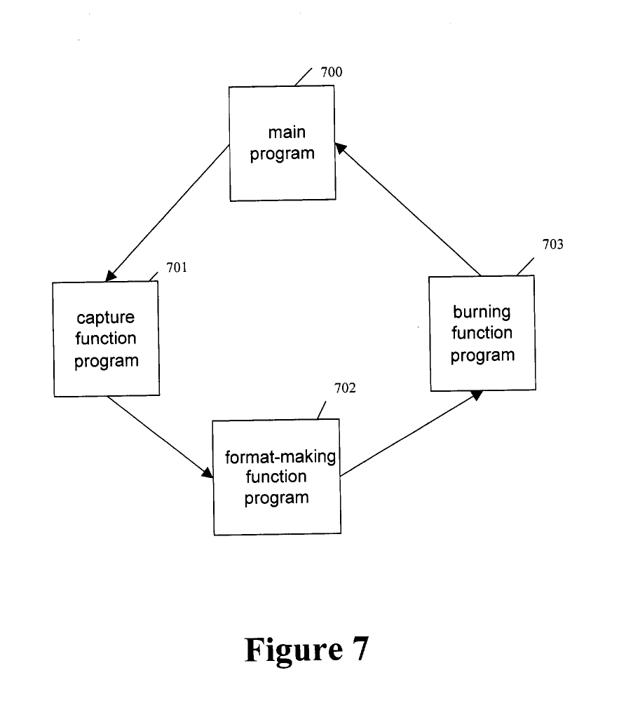

The video editing system can either apply to software-design, the video edit software comprises a main program 700, a capture function program 701, a format-making function program 702 and a burning function program 703. As shown in the FIG. 7, the calling way in the example is at least comprised of the main program 700 calls the capture function program 701,the capture function program 701 calls the format-making function program 702 and the forming-making function program 702 calls the burning function program 703. Besides that, return the main program 700 after the burning function program 703 finished the program.

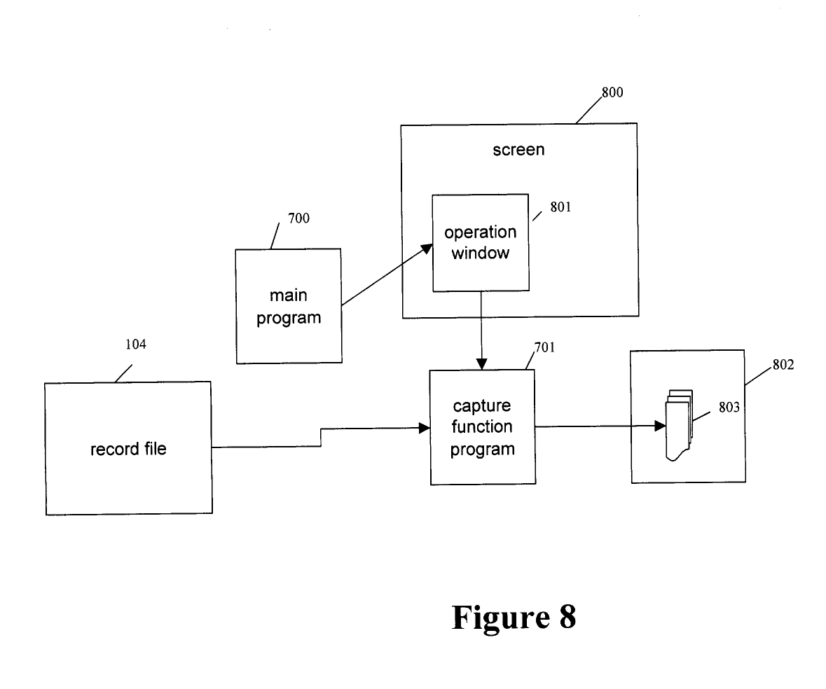

FIG. 8 illustrates how the main program 700 and the capture function program 701 work in coordination. In this figure, the main program 700 generates an operation window in the screen 800. It can let users play a plurality of video compact disk in the operation window as soon as possible to record the starting location and the ending location of the plurality disks through calling the capture function program 701. The capture function program records the plurality sections or directly uses the starting location and the ending location of the plurality sections previously set by the record file 104, and then generates a sequence of data stream 803 thereof to temporarily store it in the data buffer section 802.

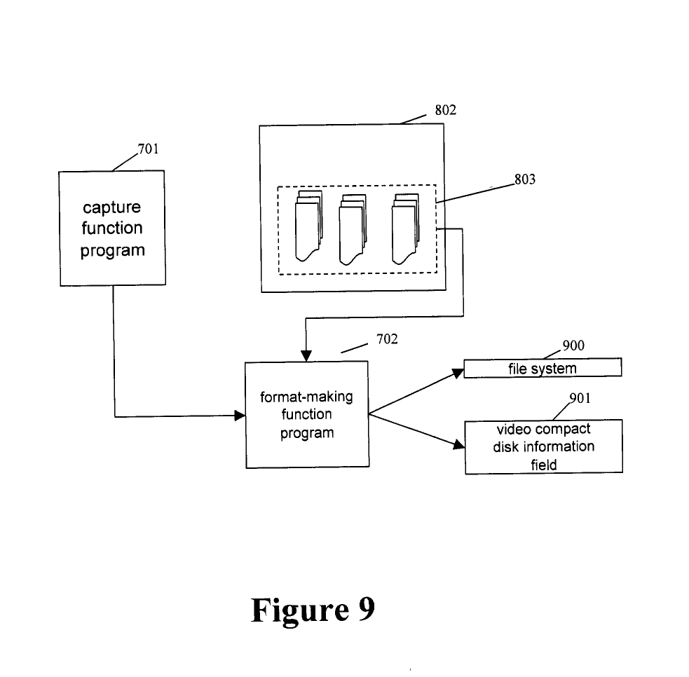

Coming after the FIG. 9, it illustrates how the capture function program 701 and the format-making function program 701 work in coordination. After the capture function program 701 finished the action in the FIG. 8, it calls the format-making function 702. The format-making function program 702 produces a file system 900 that matches the compact disk form and a video compact disk information field 901 through the data stream 803.

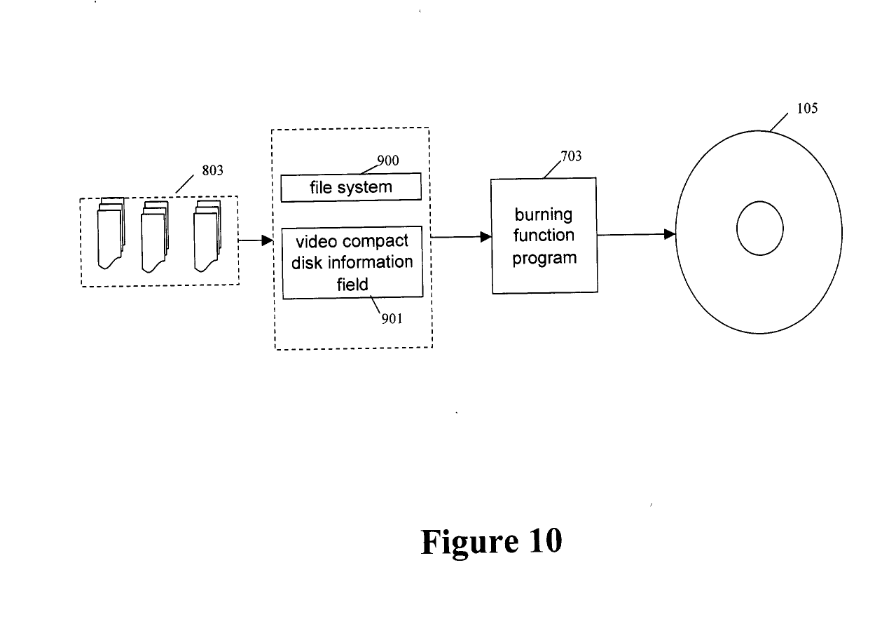

Coming after the FIG. 10, it illustrates the action of the burning function program. While the format-making function program 702 finishes the action in the FIG. 9,the data buffer section 802 has temporarily stored the data stream 803, the file system 900 and the video compact disk information field 901. The format-making function program calls the burning function program 703. The burning function program 703 checks whether the cd-rw stored a targeted compact disk 105 or not, and then records the file system 900 and video compact information data field 901 to the targeted compact disk 105. And corrects each section head and the error-detecting code of the disk to load the said data stream in sequence then burn the said data stream 803 to the targeted compact disk 105 in sequence. Finally, it becomes the video compact disk that users edit.

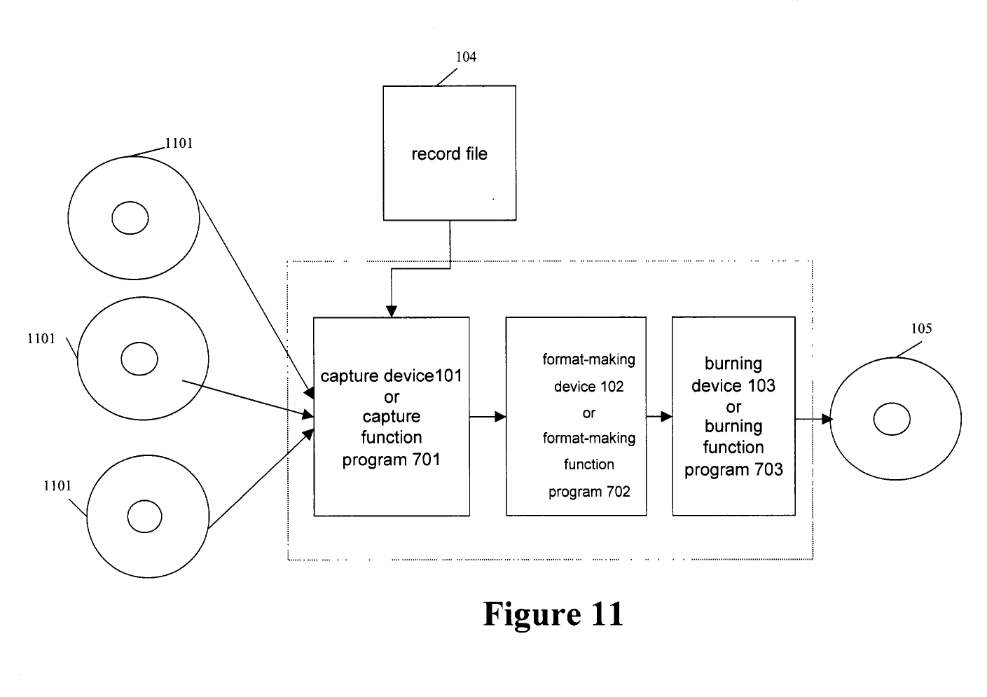

FIG. 11 illustrates the real operation action of the two said examples; the record file previously sets the capture device 101. The capture device 101 can read the specific sections of the plurality source compact disks to record them to a targeted compact disk 105 directly through the capture device 101, the format-making device 102, the burning device 103(as the description one) or directly through the capture function program 701, a format-making function program 702 and a burning function program 703(as the description two).

Although described above in connection with the preferred embodiments, one skilled in the art will appreciate that the present invention can be implemented in other embodiments while remaining within the scope of the present invention as defined in the appended claims.

What is claimed is:

1. A video editing system for dynamically editing a plurality of video information onto a targeted compact disk, comprising:
a capture device recording an starting location and an ending location of a section in at least one source compact disk to form a first information;
a format-making device generating a second information for matching a recordable disk format through said first information;
and
a burning device first recording said second information to said targeted compact disk, and then loading the specific section from said source disks according to said first information and correcting the section head and the error-detecting code of said second information to burn in said targeted compact disk.

2. The video editing system of claim 1, wherein said capture device further comprises an operation interface for capturing the section of said video information.

3. The video editing system of claim 1, wherein said first information is a data stream.

4. The video editing system of claim 3, wherein said data stream further comprises a plurality of sections.

5. The video editing system of claim 1, wherein said second information include a necessary file system and the video compact disk information of said targeted compact disk.

6. A video editing method for dynamically editing a plurality of video information onto a targeted compact disk, comprising:
recording a starting location and an ending location of a section of at least one source compact disk to form a first information;
generating a second information for matching a recordable disk format through said first information;
recording said second information to said targeted compact disk;
loading the specific section from said source compact disk in sequence and correcting the section head and the error-detecting code of said second information; and
burning said video information to said targeted compact disk.

7. The video editing method of claim 6, wherein said first information is a data stream.

8. The video editing method of claim 7, wherein said data stream comprises a plurality of sections.

9. The video editing method of claim 6, wherein said second information include a necessary file system and the video compact disk information of said targeted compact disk.

10. A video editing system for dynamically editing a plurality of video information to a targeted compact disk, comprising:
a capture device providing an operation interface to record a starting location and an ending location of a specific section in a compact disk to form a first information;
a format-making device generating a file system and a video compact disk information field for matching a recordable disk format through said first information; and
a burning device recording said file system and said video compact disk information field to said targeted compact disk, and then loading said specific section from said source compact disk and correcting the section head and the error-detecting code of said second information to burn in said target compact disk.

11. The video editing system of claim 10, wherein said first information is a data stream.

12. The video editing system of claim 11, wherein said data stream comprises a plurality of sections.

13. A video editing method for dynamically editing a plurality of video information to a targeted compact disk, comprising:
recording starting locations and ending locations of a plurality of sections to form a first information;
generating a file system and a video compact disk information field for matching a recordable disk format through said first information;
recording said file system and said video compact disk information field to said targeted compact disk;
loading said video information in sequence and correcting the section head and the error-detecting code thereof; and
burning said video information to said targeted compact disk in sequence.

14. The video editing method of claim 13, wherein said first information is a data stream.

15. The video editing method of claim 13, wherein said data stream comprises a plurality of sections.

16. A video editing software system for dynamically editing a plurality of video information to a targeted compact disk, comprising:
a main program generating an operation window for capturing sections of said video information;
a capture program recording the starting location and the ending location of said sections to form a plurality of first information;
a format-making program generating a second information for matching the recordable compact disk format through said first information; and
a burning program recording said second information data to said targeted compact disk at first, and then loading the first information and correcting the section head and the error-detecting code of said second information to burn in said targeted compact disk,
wherein said main program calling said capture program through said operation interface, said capture program generating said first information to call said format-making program, said format-making program generating said second information to call said burning program to produce said targeted compact disk.

17. The video editing software system of claim 16, wherein said first information is a data stream.

18. The video editing software system of claim 17, wherein said data stream comprises a plurality of sections.

19. The video editing software system of claim 16, wherein said second information include a necessary file system and video compact disk information of said targeted compact disk.

20. A video editing system for recording a batch of plurality video information onto a targeted disk, comprising:
a capture device recording a starting location and an ending location of at least one source disk to form information for matching a recordable disk format; and
a burning device recording said information to a preserved location of said targeted compact disk, and then loading specific sections from said source disks depending on said information and correcting the section head and the error-detecting code thereof to burn in the other locations on said targeted disk.

21. The video editing system of claim 20, wherein said capture device further comprises an operation interface for capturing the sections of said video information.

22. The video editing system of claim 20, wherein said information matches the recordable format of the multi-section.

23. The video editing system of claim 20, wherein said information matches the recordable format of the reserved track.

24. The video editing system of claim 20, wherein said preserved location is the starting track of said targeted disk for recording each video information location of said target disk.

25. A video editing software method for recording a batch of plurality video information to a targeted disk, comprising:
recording a starting location and an ending location of at least one source disk to form information for matching a recordable disk format;
recording said information to the preserved location of said targeted disk;
loading specific sections from said source disks in sequence and correcting the section head and the error-detecting code thereof;
and
burning said specific video information to said targeted disk.

26. The video editing system of claim 25, wherein said capture device further comprises an operation interface for capturing the sections of said video information.

27. The video editing system of claim 25, wherein said information matches the recordable format of the multi-section.

28. The video editing system of claim 25, wherein said information matches the recordable format of the reserved track.

29. The video editing system of claim 25, wherein said preserved location is the starting track of said targeted disk for recording each said video information location of said targeted disk.
